(19) United States
(12) Patent Application Publication
(10) Pub. No.: US 2005/0175100 A1
(43) Pub. Date: Aug. 11, 2005

(54) Data processing device and method of same, and encoding device and decoding device

(76) Inventors: Masahito Yamane, Kanagawa (JP); Nobuaki Izumi, Kanagawa (JP); Shinji Watanabe, Tokyo (JP)

Correspondence Address: FROMMER LAWRENCE & HAUG LLP, 745 FIFTH AVENUE, NEW YORK, NY, 10151, US

(21) Appl. No.: 11/049,425

(22) Filed: Feb. 2, 2005

(30) Foreign Application Priority Data
Feb. 5, 2004 (JP) P2004-029776

(51) Int. Cl. H04B 1/66

(52) U.S. Cl. 375/240.16

(57) ABSTRACT

A data processing device able to generate prediction image data at short time even in the case of using a motion vector indicating outside an effective pixel region. A motion compensation circuit generates reference outside the effective pixel region and writes it into a memory based on reference image data inside the effective pixel region stored in the memory through decoding. A motion compensation circuit, in the case that the motion vector MV indicates outside the effective pixel region, generates prediction image data based on reference image data outside the effective pixel region stored in the memory.

### BACKGROUND OF THE INVENTION

1. Field of the Invention

The present invention relates to a data processing device performing motion compensation of motion-image data and a method of the same, and an encoding device and decoding device.

2. Description of the Related Art

In recent years, a device implemented in relation to a method such as moving picture experts group (MPEG) that compresses by orthogonal transformation such as discrete cosine transform and motion compensation with handling image data as digital data, purposing transmission and accumulation of efficient information on this location and utilizing redundancy unique to image information is common in both side of information delivery such as a broadcast station and information reception in general household.

Following the MPEG method, an encoding method referred to as H264/AVC (Advanced Video Coding) realizing further high data compensation ratio is suggested.

An encoding device of the MPEG method and the H264/AVC method, in a way similar to an encoding device of the MPEG method, performs motion prediction and compensation processing to generate a motion vector and prediction image data by making a predetermined motion compensation block as a unit.

An encoding device of the MPEG method and the H264/AVC method write reference image data inside an effective pixel region generated by going through processes of inverse quantization, inverse orthogonal transformation and reconstruction after performed orthogonal transformation and quantization into a memory and read out block data inside the reference image data indicated by the already obtained motion vector from the memory to generate the prediction image data.

Incidentally, in the H264/AVC method, it is permitted to generate a motion vector indicating the outside of the above mentioned effective pixel region.

In this case, the encoding device judges whether pixel data composing block data inside the reference image data indicated by the motion vector exists inside the effective pixel or not in generating the prediction image data, in the case of judging not existing inside the effective pixel region, the encoding device copies pixel data inside the effective pixel region and generates pixel data outside the effective pixel region and uses it for generation of the prediction image.

However, the above-mentioned conventional encoding device has a problem that long processing time is required because a step of judging whether the pixel data is data inside the effective pixel region or not is required whenever the pixel data is read out from the memory for generating the prediction image data.

Also in the case of generating prediction image data in a decoding device, there is a problem similar to the above mentioned encoding device.

### SUMMARY OF THE INVENTION

The present invention is made in consideration of the above mentioned conventional technique, and an object of the present invention is to provide a data processing device able to generate prediction image data at short times even in the case of using a motion vector indicating the outside of an effective pixel region, a method of the same, and an encoding device and a decoding device.

To solve the problem of the above mentioned conventional technique, a data processing device of a first invention is a data processing device for generating prediction image data of image data as an encoding target or a decoding target based on a motion vector and first reference image data of an effective pixel region, having a memory for storing the first reference image data, a preprocessor for generating second reference image data of a predetermined non-effective pixel region around the effective pixel region and writing it into the memory based on the first reference image data stored in the memory before generation of the prediction image data, a reader for reading out the second reference image data written into the memory by the preprocessor based on the motion vector in the case that the motion vector indicates the non-effective pixel region, and a generator for generating the prediction image data based on the second reference image data read out by the reader.

An operation of the first invention is explained as the following.

First, the preprocessor generates second reference image data of a predetermined non-effective pixel region around the effective pixel region based on the first reference data stored in the memory before generating the prediction image data.

Next, in the case that the motion vector indicates the non-effective pixel region, the reader reads out the second reference image data written into the memory by the preprocessor based on the motion vector.

Next, the generator generates the prediction image data based on the second reference data read out by the reader.

A second data processing method of a second invention is a data processing method generating prediction image data of image data of an encoding target or a decoding target based on a motion vector and first reference image data of an effective pixel region, having a first step of generating second reference image data of a predetermined non-effective pixel region around the effective pixel region based on the first reference image data stored in a memory and writing it into the memory, a second step of reading out the second reference image data written into the memory in the first step based on the motion vector in the case that the motion vector indicates the non-effective pixel region, and a third step of generating the prediction image data based on the second reference image data read out from the memory in the second step.

An operation of the data processing method of the second invention is explained as the following.

First, at the first step, the second reference image data of a predetermined non-effective pixel region around the effective pixel region is generated and is wrote into the memory based on the first reference image data stored in the memory.

Next, at the second step, in the case that the motion vector indicates the non-effective pixel region, the reference image data wrote into the memory at the first step is read out based on the motion vector.

Next, at the third step, the prediction image data is generated based on the second reference image data read out from the memory at the second step.

An encoding device of a third invention is an encoding device, having an encoder for encoding difference between encoded image data and prediction image data, a memory for storing first reference image data of an effective pixel region, a motion prediction circuit for generating a motion vector of the encoded image data, and a motion compensation circuit for generating the prediction image data based on the motion vector generated by the motion prediction circuit and the reference image data stored in the memory, wherein the motion compensation circuit has a preprocessor for generating second reference image data of a predetermined non-effective pixel region around the effective pixel region and writing it into the memory based on the first reference image data stored in the memory before generation of the prediction image data, a reader for reading out the second reference image data written in the memory by the preprocessing process based on the motion vector in the case that the motion vector generated by the motion prediction circuit indicates the non-effective pixel region, and, a generator for generating the prediction image data based on the second reference image data read out by the reader.

An operation of the encoding device of the third invention is explained as the following.

The encoder encodes difference of encoded image data and prediction image data.

The motion prediction circuit generates the motion vector of the encoded image data.

Next, the motion compensation circuit generates the prediction image data based on the motion vector generated by the motion prediction circuit and the reference image data stored in the reference image data.

An operation of the motion compensation circuit is equal to the data processing device of the first invention.

A decoding device of a fourth invention is a decoding device having a decoder decoding image data as a decoding target, a memory for storing first reference image data of a effective pixel region after decoding, a motion compensation circuit for generating prediction image data based on a motion vector added to image data as the decoding target and the first reference image data read out from the memory, and a calculator for adding the prediction image data generated by the motion compensation circuit and image data decoded and generated by the decoder, wherein the motion compensation circuit has a preprocessor for generating second reference image data of a predetermined non-effective pixel region around the effective pixel region and writing it into the memory based on the first reference image data stored in the memory before generation of the prediction image data, a reader for reading out the second reference image data written in the memory by the preprocessing process based on the motion vector in the case that the motion vector generated by the motion prediction circuit indicates the non-effective pixel region, and a generator for generating the prediction image data based on the second reference image data read out by the reader.

An operation of the decoding device of the fourth invention is explained as the following.

The decoder decodes image data as a decoding target.

The motion compensation circuit generates the prediction image data based on the motion vector added to the image data as a decoding target and the first reference image data read out from the memory.

Next, the calculator adds the prediction image data generated by the motion compensation circuit with the image data that the decoder decoded and generated.

According to the present invention, even in the case of using a motion vector indicating the outside of an effective pixel region, a data processing device able to generate prediction image data at shot times, a method of the same, an encoding device and a decoding device can be provided.

### BRIEF DESCRIPTION OF THE DRAWINGS

These and other objects and features of the present invention will become clearer from the following description of the preferred embodiments given with reference to the accompanying drawings, in which:

FIG. 1 is a block diagram of a communication system of a first embodiment of the present invention;

FIG. 2 is a functional block diagram of an encoding device shown in FIG. 1;

FIG. 3 is a view for explaining reference image data of an effective pixel region stored in a memory shown in FIG. 2 and reference data outside a non-effective pixel region;

FIG. 4 is a view for explaining a reference motion compensation block used by a motion compensation circuit shown in FIG. 2;

FIG. 5 is a block diagram of a motion compensation circuit shown in FIG. 2;

FIG. 6 is a view for explaining processing of a non-effective pixel region composing circuit shown in FIG. 5;

FIG. 7 is a view for explaining processing of a non-effective pixel region composing circuit shown in FIG. 5;

FIG. 8 is a view for explaining a motion compensation block used at an encoding device shown in FIG. 2;

FIG. 9 is a view of explaining processing of an MV transformation circuit shown in FIG. 5;

FIGS. 10A and 10B are views of explaining processing of an MV transformation circuit shown in FIG. 5;

FIG. 11 is a flowchart for explaining an operation example of a motion compensation circuit shown in FIG. 5;

FIG. 12 is a flowchart for explaining a step ST2 shown in FIG. 11 in detail;

FIG. 13 is a view for explaining processing of a motion compensation circuit of an encoding device of a second embodiment of the present invention;

FIG. 14 is a view for explaining processing of a motion compensation circuit of an encoding device of a second embodiment of the present invention;

FIG. 15 is a block diagram of a decoding device of a third embodiment of the present invention;

FIG. 16 is a block diagram of a motion prediction/compensation circuit shown in FIG. 15;

FIG. 17 is a view for explaining a modification example of embodiments of the present invention.

### DESCRIPTION OF THE PREFERRED EMBODIMENTS

Hereinafter, an encoding device of H264/AVC method according to preferred embodiments of the present invention will be described with reference to the accompanying drawings.

### First Embodiment

Hereinafter, an encoding device of a communication system of a first embodiment will be explained in detail.

The present embodiment corresponds to a first, a second and a third invention.

In the present embodiment, the case that image data becoming as an encoding target is data obtained by noninterlace scanning will be explained with examples.

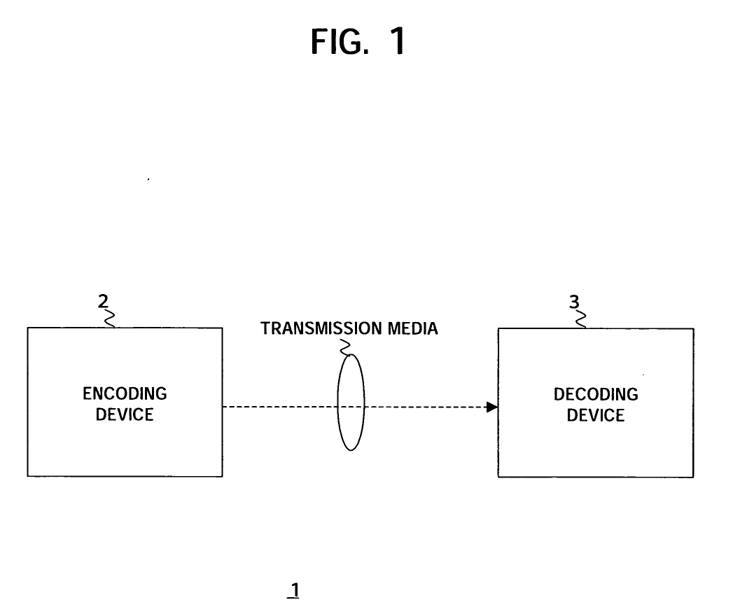

FIG. 1 is a schematic diagram of a communication system l of the present embodiment.

As shown in FIG. 1, the communication device 1 has an encoding device 2 set in the transmission side and a decoding device 3 set in the reception side.

The communication system 1 generates frame image data (bit stream) compressed by orthogonal transformation such as discrete cosine transformation and Karhunen-Loeve transformation and motion compensation, and transmits the frame image data via a transmission media such as satellite broadcasting wave, cable television net, telephone line net and mobile phone line net after modulating it in the encoding device 2 of the transmission side.

In the reception side, after decoding a received image signal, frame image data stretched by inverse transformation of orthogonal transformation and motion compensation in the above mentioned modulating is generated and utilized.

Note that, the above transmission media may be recording media such as optical disk, magnetic disk and semiconductor memory.

The decoding device 3 shown in FIG. 1 performs decoding corresponding to encoding of the encoding device 2.

The decoding device 3 will be explained in a third embodiment in detail.

Hereinafter, the encoding device 2 shown in FIG. 1 will be explained.

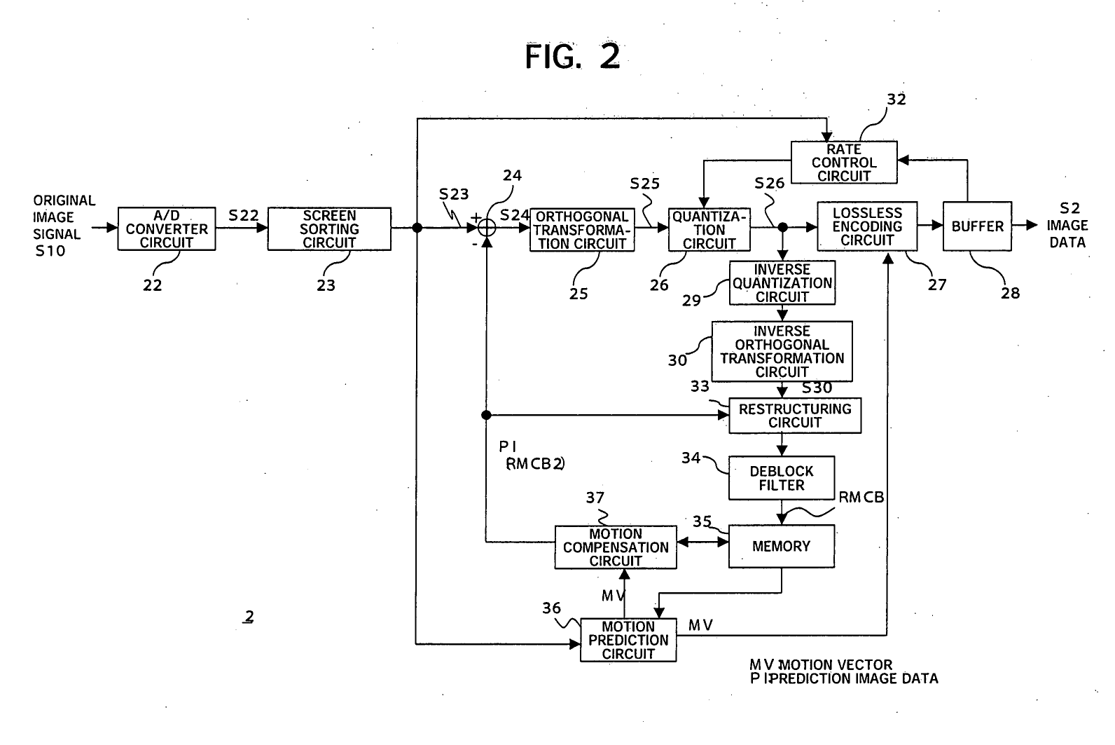

FIG. 2 is a whole block diagram of the encoding device 2 shown in FIG. 1.

As shown in FIG. 2, the encoding device 2 has, for example, an A/D converter circuit 22, a screen sorting circuit 23, a calculation circuit 24, an orthogonal transformation circuit 25, a quantization circuit 26, a lossless encoding circuit 27, a buffer 28, an inverse quantization circuit 29, an inverse orthogonal transformation circuit 30, a rate control circuit 32, a restructuring circuit 33, a deblock filter 34, a memory 35, a motion prediction circuit 36 and a motion compensation circuit 37.

In the present embodiment, the encoding device 2 corresponds to an encoding device of a third invention.

Further, the motion compensation circuit 37 corresponds to a data processing device of a first invention and a motion compensation circuit of a third invention.

Hereinafter, components of the encoding device 2 will be explained.

The A/D converter circuit 22 converts an original image signal S10 composed of an inputted analog luminance signal Y, a color-difference signal Cb, Cr to a digital image signal S22 and outputs it to the screen sorting circuit 23.

The screen sorting circuit 23 sorts the image data S22 inputted from the A/D converter circuit 22 in encoding order depending on a group of pictures (GOP) structure composed of its picture type I, P, B and outputs the sorted image data S23 to the calculation circuit 24, the rate control circuit 32 and the motion prediction circuit 36.

The calculation circuit 24 generates image data S24 indicating difference between a motion compensation block MCB as a processing target inside the image data S23 and a motion compensation block RMCB2 of prediction image data PI inputted from a motion prediction/compensation circuit corresponding to the MCB and outputs it to the orthogonal transformation circuit 25.

The orthogonal transformation circuit 25 performs the orthogonal transformation such as discrete cosine transformation and Karhunen-Loeve transformation to the image data S24 to generate image data S25 (for example DCT coefficient) and outputs it to the quantization circuit 26.

The quantization circuit 26 quantizes the image data S25 with a quantization scale inputted from the rate control circuit 32 to generate image data S26 and outputs it to the lossless encoding circuit 27 and the inverse quantization circuit 29.

The lossless encoding circuit 27 stores image data performed variable-length coding or arithmetic coding in the buffer 28.

At this time, the lossless encoding circuit 27 codes a motion vector MV inputted from the motion prediction circuit 36 and stores in header data in the case that inter-prediction coding is performed.

The image data stored in the buffer 28 is transmitted after performed modulation and so on.

The inverse quantization circuit 29 generates a signal that the image data S26 of the motion compensation block MCB of the reference image data referred from other motion compensation block MCB is inverse-quantized and outputs it to the inverse orthogonal transformation circuit 30.

The inverse orthogonal transformation circuit 30 performs inverse transformation of orthogonal transformation in the orthogonal transformation circuit 25 to the image data S26 inputted from the inverse quantization circuit 29 and outputs it to the restructuring circuit 33.

The restructuring circuit 33 adds the motion compensation block RMCB2 corresponding to prediction image PI inputted from the motion compensation circuit 37 and the motion compensation block MCB of the image data S26 inputted from the inverse orthogonal transformation circuit 30 and restructures a reference motion compensation block RMCB referred in motion prediction/compensation processing and outputs it to the deblock filter 34.

The deblock filter 34 removes a block distortion from the restructured reference motion compensation block RMCB inputted from the restructuring circuit 33 and writes it into the memory 35.

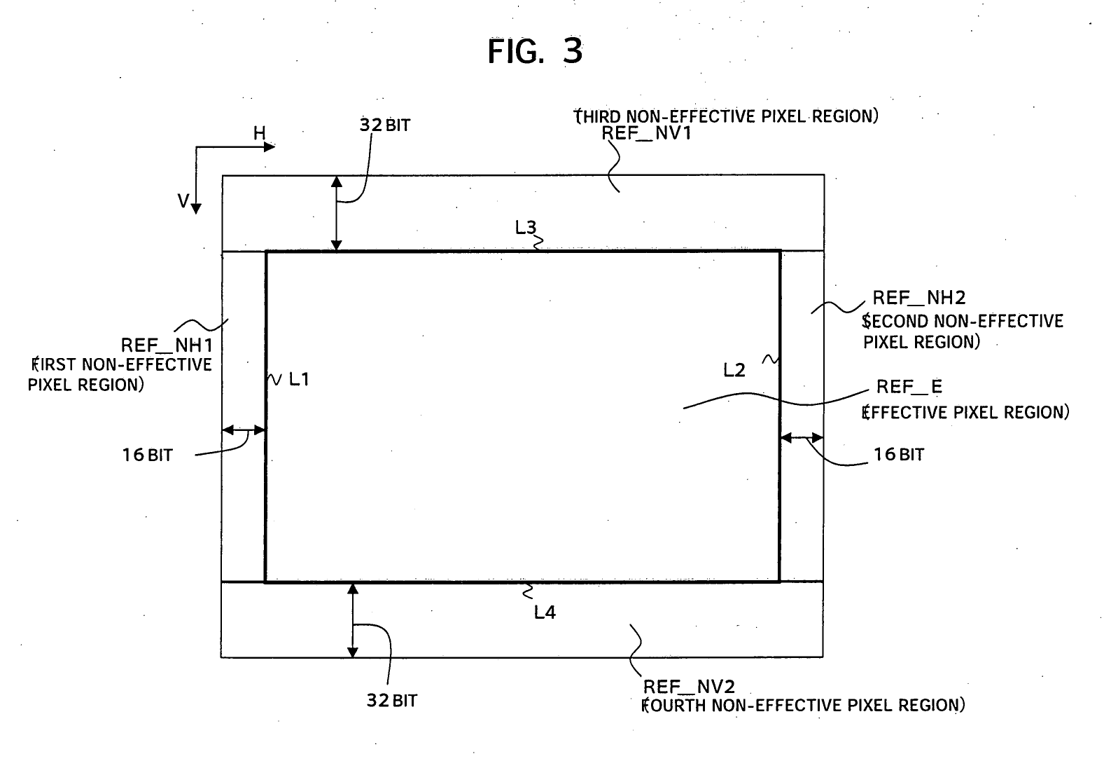

At the time that the deblock filter 34 writes all the reference motion compensation block RMCB composing one picture into the memory 35, as shown in FIG. 3, reference image data REF_E for one picture is stored in the memory 35. The reference image data REF_E is image data about an effective pixel region and does not include image data about a non-effective pixel region of a predetermined range around the effective pixel region.

The rate control circuit 32 generates a quantization parameter QP so that a portion having high complexity in the image is quantized finely and a portion having low complexity in the image is quantized roughly base on, for example, the image data S23 inputted from the screen sorting circuit 23.

Then, the rate control circuit 32 generates a quantization scale based on the quantization parameter QP generated above and the image data read out from the screen sorting circuit 23 and outputs it to the quantization circuit 26.

The motion prediction circuit 36 generates a motion vector MV by making the motion compensation block MCB of the image data S 23 inputted from the screen sorting circuit 23 as a unit.

At this time, the motion prediction circuit 36 is possible to generate a motion vector MV indicating the outside of an effective pixel region corresponding to the reference image data REF_E stored in the memory 35 actually by a predetermined prediction algorithm.

The motion compensation circuit 37 generates prediction image data PI of the image data S23 based on the motion vector MV inputted from the motion prediction circuit 36 and the reference image data stored in the memory 35, and outputs it to the calculation circuit 24 and the restructuring circuit 33.

Concretely, the motion compensation circuit 37 reads out a reference motion compensation block RMCB1 inside the reference image data indicated by the motion vector MV inputted from the motion prediction circuit 36 about the motion compensation block MCB about each motion compensation block MCB composing the image data S23 and outputs the reference motion compensation block RMCB2 generated based on the read out reference motion compensation block RMCB1 to the calculation circuit 24 and the restructuring circuit 33.

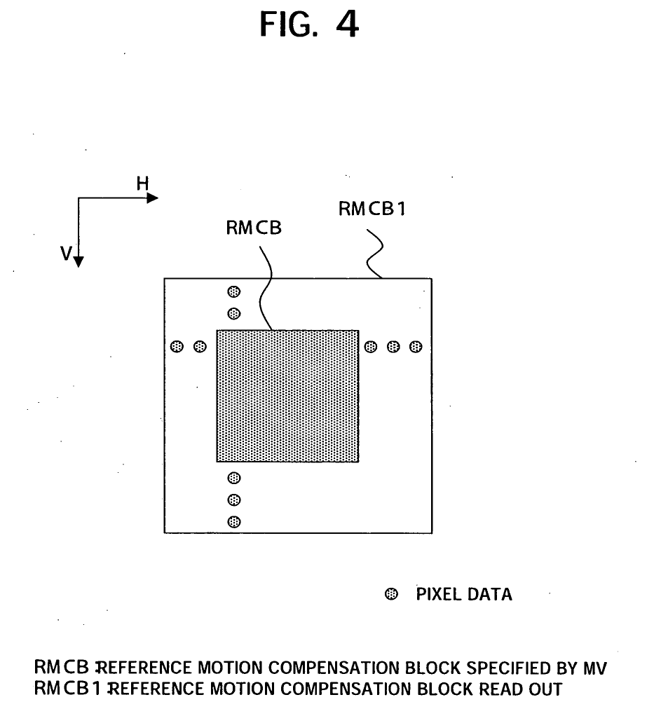

Here, the reference motion compensation block RMCB1 is, as shown in FIG. 4, image data added pixel data of two pixels in the side scanned previously and 3 pixels in the side scanned behind in a vertical direction, two pixels in the side scanned previously and 3 pixels in the side scanned behind in a horizontal direction for the reference motion compensation block RMCB indicated by the motion vector MV.

As mentioned above, the reference motion compensation block RMCB1 is composed by a generation algorithm of the prediction image data PI and restructuring image.

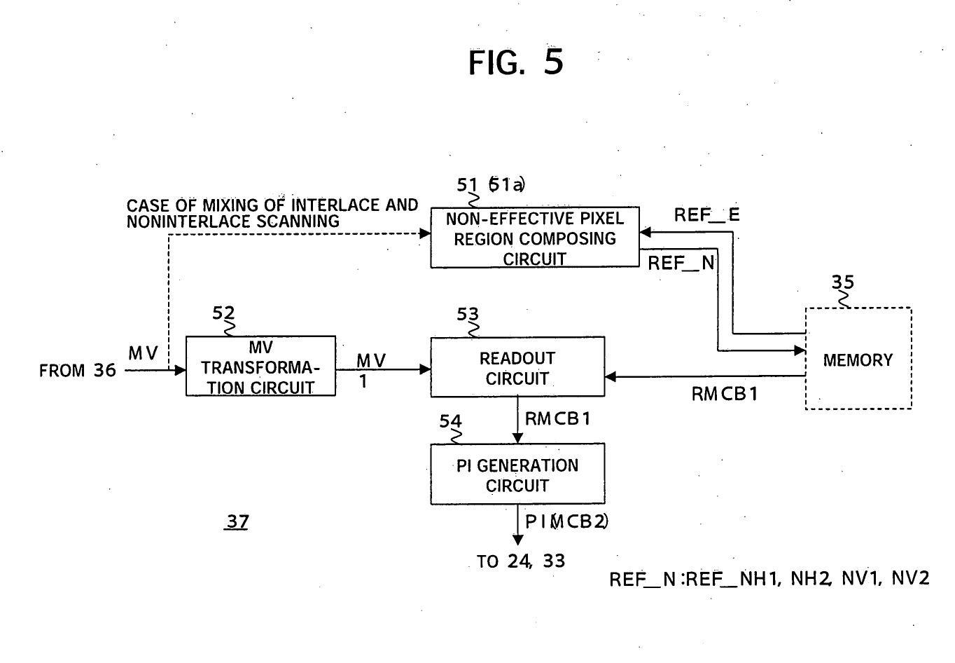

FIG. 5 is a block diagram of the motion compensation circuit.37 shown in FIG. 1.

As shown in FIG. 5, the motion compensation circuit 37 has, for example, a non-effective pixel region composing circuit 51 an MV transformation circuit 52, a readout circuit 53 and a PI generation circuit 54.

Here, the non-effective pixel region composing circuit 51 and the MV transformation circuit 52 correspond to a preprocessor of a first and a third invention, the read out circuit 53 corresponds to a reader of a first and a third invention, and the PI generation circuit 54 corresponds to a generator of a first and a third invention.

Further, reference image data REF_E of the effective pixel region shown in FIG. 5 corresponds to first reference image data of a first to a third invention, and reference image data of non-effective pixel region REF_N corresponds to second reference image data of a first to a third invention.

Further, the motion compensation block MCB corresponds to a block data of the present invention.

The non-effective pixel region composing circuit 51, based on reference image data REF_E of an effective pixel region shown in FIG. 3 read out from a memory 35, generates reference image data REF_N of a non-effective pixel region around the effective pixel region and write it into the memory 35.

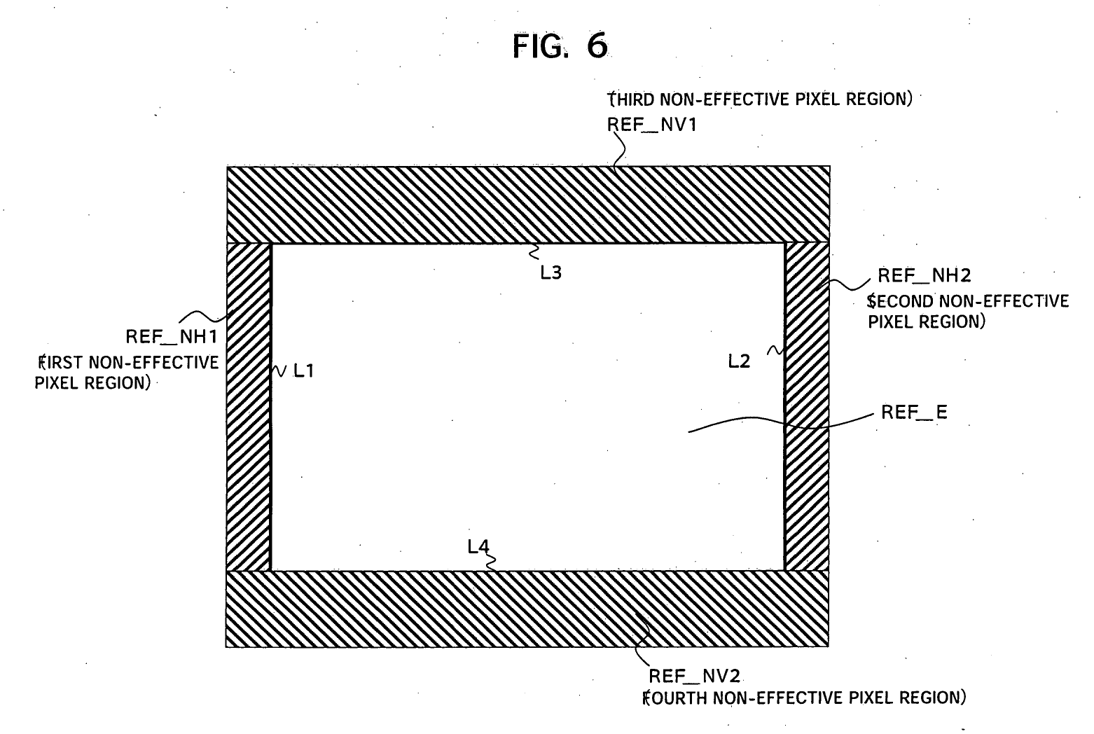

The reference image data REF_N is, as shown in FIG. 6, composed of reference image data REF_NH1, NH2, NV1 and NV2.

As shown in FIG. 6, the reference image data REF_NH1 is data concerning a first non-effective pixel region adjacent to the effective pixel region at a first side L1 lengthening in a vertical direction V perpendicular to a screen scanning direction and having a length in a horizontal direction H of 16 bit length.

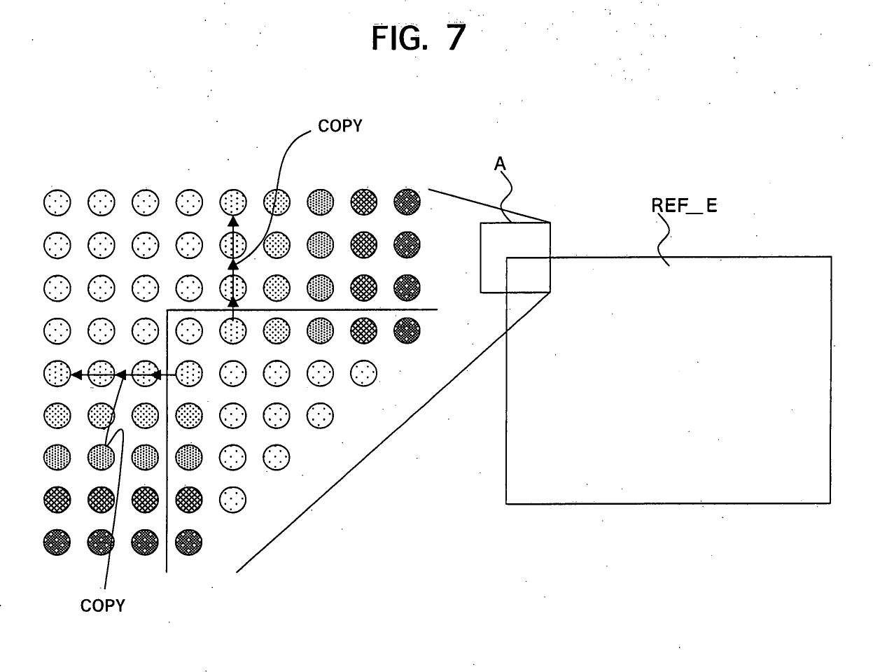

The non-effective pixel region composing circuit 51, as shown in FIG. 7, generates the reference image data REF_NH1 by generating pixel data of pixel position of the above mentioned first non-effective pixel region by copying pixel data inside the effective pixel region on the first side L1 having the same position in the vertical direction V.

Further, the reference image data REF_NH2 is data concerning a second non-effective pixel region adjacent to the effective pixel region at the second side L2 opposed to the above mentioned first side L1 and lengthening in a vertical direction V and having a length in a horizontal direction H of 16 bit length.

The non-effective pixel region composing circuit 51 generates the reference image data REF_NH2 by generating pixel data of pixel position of the above mentioned second non-effective pixel region by copying pixel data inside the effective pixel region on the second side L2 having the same position in the vertical direction V.

Further, the reference image data REF_NV1 is data concerning a third non-effective pixel region adjacent to the effective pixel region at a third side L3 lengthening in a horizontal direction H parallel with a screen scanning direction and having a length in a vertical direction V of 32 bit length.

The non-effective pixel region composing circuit 51, as shown in FIG. 7, generates the reference image data REF_NV1 by generating pixel data of pixel position of the above mentioned third non-effective pixel region by copying pixel data inside the effective pixel region on the third side L3 having the same position in the horizontal direction H.

Further, the reference image data REF_NV2 is data concerning a third non-effective pixel region adjacent to the effective pixel region at a fourth side L4 opposed to the above mentioned third side L3 and lengthening in a horizontal direction H and having a length in a vertical direction V of 32 bit length.

The non-effective pixel region composing circuit 51 generates the reference image data REF_NV2 by generating pixel data of pixel position of the above mentioned fourth non-effective pixel region by copying pixel data inside the effective pixel region on the fourth side L4 having the same position in the horizontal direction H.

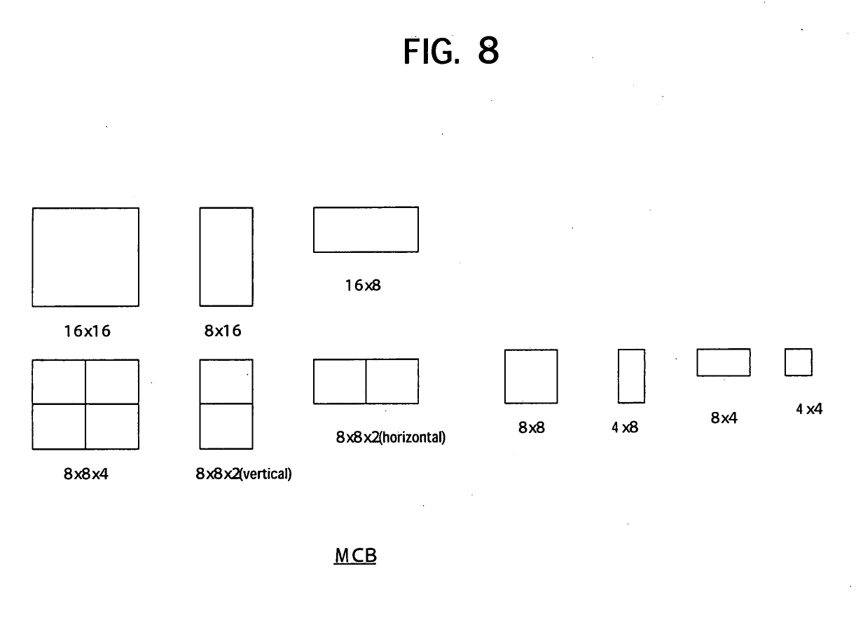

Here, as mentioned above, a reason why the bit length in a horizontal direction H is defined as 16, and the bit length in a vertical direction V is defined as 32 is, as shown in FIG. 8, because the maximum size of a motion compensation block MCB is 16 (H)×16 (V), and the size of a macro block pair mentioned later becomes 16 (H)×32 (V).

The MV transformation circuit 52, in the case that the motion vector MV inputted from the motion prediction circuit 36 indicates the outside of both of the effective pixel region shown in FIG. 3 and the first to the fourth non-effective pixel region, transforms it so as to indicate the inside of the nearest first to fourth non-effective pixel region and generates a new motion vector MV1.

Concretely, in the case that a whole or a portion of the reference motion compensation block RMCB1 inside the reference image data identified by the motion vector MV indicates the outside of both of the effective pixel region and the first to fourth non-effective pixel region, the MV transformation circuit 52 generates the motion vector MV1 so that the whole of the reference motion compensation block RMCB1 falls in the first to the fourth non-effective pixel region.

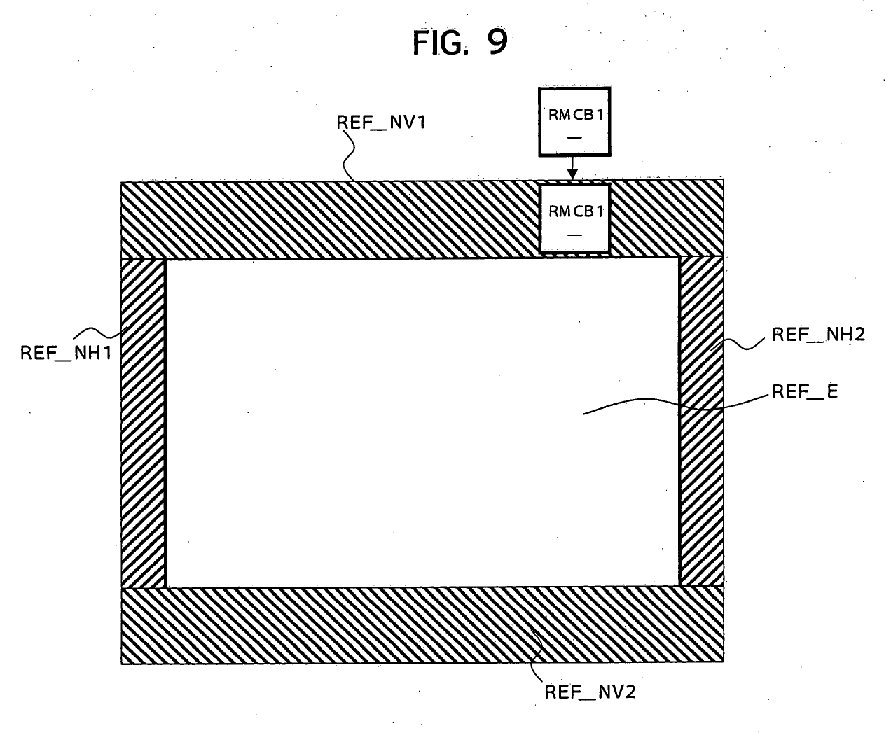

Herewith, for example, as shown in FIG. 9, the reference motion compensation block RMCB1 located in the outside of both of the effective pixel region and the first to the fourth non-effective pixel region is moved to the third non-effective pixel region.

Further, in the case that even if the reference motion compensation block RMCB1 inside the reference image data indicated by the motion vector MV inputted from the motion prediction circuit 36 is moved, the whole of the reference motion compensation block RMCB1 does not fall in the first to the fourth non-effective pixel region, the MV transformation circuit 52 divides the RMCB1 to any size shown in FIG. 8 and obtains a plurality of the motion compensation blocks MCB, and moves them so that the reference motion compensation block RMCB1 corresponding to this falls in the first to the fourth non-effective pixel region to generate a motion vector MV1 corresponding to each of the reference motion compensation block RMCB after moving.

At this time, about the motion compensation block MCB that becomes a processing target in the image data S23, division is performed in a similar way.

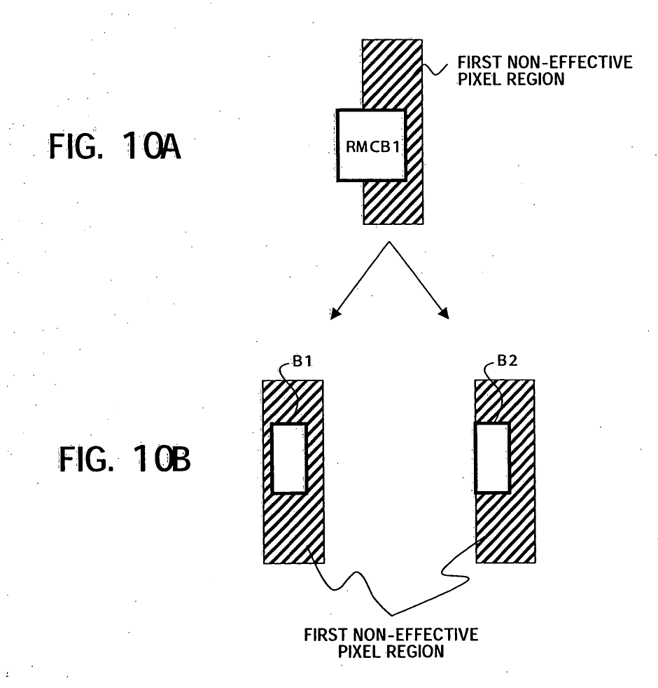

The MV transformation circuit 52 divides a reference motion compensation block RMCB1 of 21×21 corresponding to, for example, a motion compensation block MCB of 16×16 shown in FIG. 10A into, as shown in FIG. 10B, two reference motion compensation blocks B1, B2 of 13×21 corresponding to two motion compensation blocks of 8×16 respectively.

Then, the MV transformation circuit 52 moves the reference motion compensation block B2 to the first non-effective pixel region.

At this time, the MV transformation circuit 52 divides also a motion compensation block MCB of the processing target into two motion compensation blocks of 8×16 in a similar way and generates a motion vector MV1 according to the position of the reference motion compensation block after the above mentioned moving about each of them.

The readout circuit 53 reads out pixel data composing the reference motion compensation block RMCB1 indicated by the motion vector MV1 inputted from the MV transformation circuit 52 from the memory 35 and generates it to the PI generation circuit 54.

At this time, by the processing of the above mentioned non-effective pixel region composing circuit 51 and the MV transformation circuit 52, all pixel data of the reference motion compensation block RMCB1 indicated by the motion vector MV1 is stored inside the memory 35. Therefore, each time the readout circuit 53 reads out pixel data of the reference motion compensation block RMCB1 from the memory 35, it is not necessary to judge whether the pixel data is data inside the effective pixel region or not, hence processing burden can be made smaller than conventional processing.

The PI generation circuit 54 generates a motion compensation block MCB2 composing the prediction image data PI based on pixel data composing the reference motion compensation block RMCB1 inputted from the readout circuit 53 and outputs it to the calculation circuit 24 and the restructuring circuit 33.

Hereinafter, an operation example of the motion prediction circuit 36 shown in FIG. 5 and the motion compensation circuit 37.

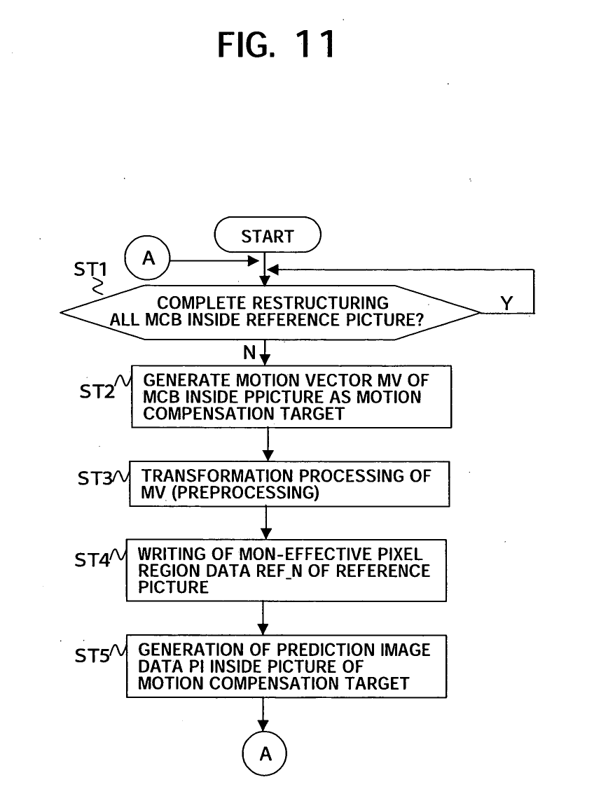

FIG. 11 is a flowchart for explaining an operation example of the motion prediction circuit 36 shown in FIG. 5 and the motion compensation circuit 37.

Step ST1:

The motion compensation circuit 37 judges whether all pixel data composing the reference image data REF_E inside the effective pixel region of the reference image data referred by the motion compensation block MCB inside the image data S23 that becomes a generation target (a processing target) of the motion vector MV is written into the memory 35 through decoding processing or not, and if judging that it was written, progresses to a step ST2.

Here, the above mentioned decoding processing is a processing of the inverse quantization circuit 29, the inverse orthogonal transformation circuit 30, the restructuring circuit 33 and the deblock filter 34.

Step ST2:

The motion prediction circuit 36 generates the motion vector MV by making the motion compensation block MCB of the image data S23 inputted from the screen sorting circuit 23 as a unit.

At this time, the motion compensation block 36 is possible to generate the motion vector MV indicating the outside of the effective pixel region corresponding to the reference image data REF_E stored in the memory 35 actually by a predetermined prediction algorithm.

Step ST3:

The MV transformation circuit 52 transforms the motion vector MV inputted from the motion prediction circuit 36 to a new motion vector MV1 indicating the inside of the effective pixel region and the first to the fourth non-effective pixel region shown in FIG. 3 and outputs it to the readout circuit 53.

The processing of the MV transformation circuit 52 will be explained by using a flowchart later.

Step ST4:

The non-effective pixel region composing circuit 51 generates the reference image data REF_N of the non-effective pixel region around the effective pixel region based on the reference image data REF_E of the effective pixel region shown in FIG. 3 read out from the memory 35, and writes it into the memory 35.

Concretely, the non-effective pixel region composing circuit 51 generates reference image data REF_NH1, NH2, NV1 and NV2 shown in FIG. 6 as reference image data REF_N, and writes it into the memory 35.

Step ST5:

The readout circuit 53 reads out image data composing the reference motion compensation block RMCB1 indicated by the motion vector MV inputted from the MV transformation circuit 52 from the memory 35, and outputs it to the PI generation circuit 54.

Then, the PI generation circuit 54 generates a motion compensation block MCB2 composing prediction image data based on pixel data composing the reference motion compensation block RMCB1 inputted from the readout circuit 53, and outputs it to the calculation circuit 24 and the restructuring circuit 33.

Hereinafter, a processing of a step ST2 shown in FIG. 11 will be explained in detail.

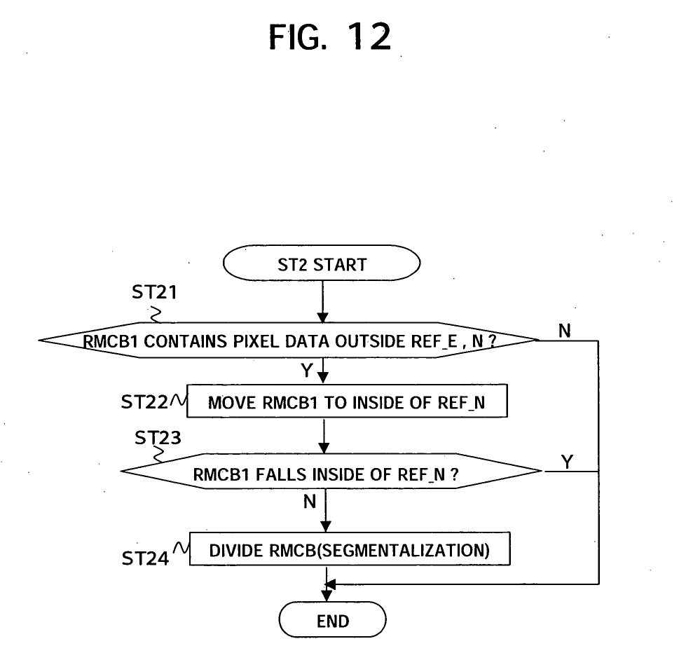

FIG. 12 is a flowchart for explaining processing of the step ST2 shown in FIG. 11.

Step ST21:

The MV transformation circuit 52 judges whether the motion vector MV inputted from the motion prediction circuit 36 indicates the outside of both of the effective pixel region and the first to the fourth non-effective pixel region shown in FIG. 3 or not, and if judging that it indicates those, progresses to a step ST 22.

Step ST22:

The MV transformation circuit 52 transforms the above mentioned motion vector MV so as to indicate the inside of the first to the fourth non-effective pixel region nearest from a portion that the motion vector MV indicates, and generates a new motion block MV1.

Concretely, in the case that a whole or a portion of the reference motion compensation block RMCB1 inside the reference image data indicated by the motion vector MV locates in the outside of both of the effective pixel region and the first to the fourth non-effective pixel region, the MV transformation circuit 52 transforms the motion vector MV so that the whole of the reference motion compensation block RMCB1 locates inside the first to the fourth non-effective pixel region and generates a motion vector MV1.

Step ST23:

After moving the reference motion compensation block RMCB1 inside the reference image data indicated by the motion vector MV inputted from the motion prediction circuit 36, the MV transformation circuit 52 judges whether the whole of the reference motion compensation block RMCB1 falls within the first to the fourth non-effective pixel region or not, and if judging that it do not fall, progresses to a step ST24.

Step ST24:

The MV transformation circuit 52 divides the above mentioned motion compensation block MCB1 into any size shown in FIG. 8, obtains a plurality of motion compensation blocks MCB and generates a motion vector MV1 corresponding to each of a plurality of motion compensation blocks MCB so that the reference motion compensation block RMCB1 corresponding to these MCB falls within the first to the fourth non-effective pixel region.

At this time, the motion compensation block MCB that becomes a processing target inside the image data S23 is also divided.

Hereinafter, a whole operation of the encoding device 2 shown in FIG. 2 will be explained.

When an original image signal S10 is inputted, the original image signal S10 is transformed into digital image data in the A/D converter circuit 22.

Next, according to a GOP structure of image compression information becoming as an output, sorting of pictures in the image data S22 is performed in the screen sorting circuit 23, thereby the obtained image data D23 is outputted to the calculation circuit 24, the rate control circuit 32 and the motion prediction circuit 36.

Next, the calculation circuit 24 detects difference between the motion compensation block MCB composing the image data S23 from the screen sorting circuit 23 and the prediction motion compensation block RMCB2 (prediction image data PI) from the motion prediction/compensation circuit 39 and outputs image data S24 showing its difference to the orthogonal transformation circuit 25.

Next, the orthogonal transformation circuit 25 performs the orthogonal transformation such as discrete cosine transformation and Karhunen-Loeve transformation to the image data S24 and outputs it to the quantization circuit 26.

Next, the quantization circuit 26 quantizes the image data S25 and outputs image data S26 showing quantized transformation coefficient to the lossless encoding circuit 27 and the inverse quantization circuit 29.

Next, the lossless encoding circuit 27 performs lossless encoding such as variable-length coding or arithmetic coding to the image data S26 and adds the motion vector MV inputted from the motion prediction circuit 36 to a header to generate image data, and accumulates it in the buffer 28.

Further, the rate control circuit 32 controls a quantization rate in the quantization circuit 26 based on the image data S23 and image data from the buffer 28.

Further, the inverse orthogonal transformation circuit 30 performs inverse-quantization to the image data S26 inputted from the quantization circuit 26 and outputs it to the restructuring circuit 33.

The restructuring circuit 33 adds the prediction image data PI from the motion compensation circuit 37 and the image data S30 from the inverse orthogonal transformation circuit 30 to generate reference image data that is restructured image, and outputs it to the deblock filter 34.

The deblock filter 34 removes a block distortion of the reference image data inputted from the restructuring circuit 33 and writes it into the memory 35..

Further, the motion prediction circuit 36 generates a motion vector MV of a motion compensation block MCB that is a processing target based on the image data S23 from the screen sorting circuit 23, and outputs it to the motion compensation circuit 37.

Then, the motion compensation circuit 37 performs the processing explained in FIG. 3 to FIG. 12 to generate prediction image data PI, and outputs it to the calculation circuit 24 and the restructuring circuit 33.

As explained above, in the encoding device 2, before generating prediction image data PI in the motion compensation circuit 37, the motion compensation circuit 37 generates reference image data REF_NH1, NH2, NV1 and NV2 of the first to the fourth non-effective pixel region of the outside of the effective pixel region shown in FIG. 6, and writes it into the memory 35.

Then, the compensation circuit 37 reads out pixel data of the reference motion compensation block RMCB indicated by the motion vector MV generated by the motion prediction circuit 36 from the memory 35 and uses for generating the prediction image data PI without judging whether the pixel data is data inside the effective pixel region or not.

Therefore, according to the encoding device 2, compared with a conventional device, prediction image data PI can be generated at short times.

Further, in the encoding device 2, as explained by using FIG. 9 and FIG. 10, the motion vector MV is transformed to generate a new motion vector MV1 by the MV translation circuit 52 of the compensation circuit 37 shown in FIG. 5 so that the reference motion compensation block RMCB indicated by the motion vector MV falls in the first to the forth non-effective pixel region. Then, the reference motion compensation block RMCB indicated by the motion vector MV1 is read out from the memory 35 in the readout circuit 35.

Therefore, according to the encoding device 2, even in the case that the motion vector MV indicates the outside of both of the effective pixel region and the first to the fourth non-effective pixel region, the reference motion compensation block RMCB can be read out from the memory 35 based on the motion vector MV1.

That is to say, a situation that the reference motion compensation block RMCB using for generation of the prediction image data PI cannot be read out from the memory 35 can be avoided.

### Second Embodiment

The present embodiment corresponds to a first, a second and a third invention in a way similar to the first embodiment.

An encoding device of the present embodiment is equal to the encoding device 2 of the first embodiment except for processing of the non-effective pixel region composing circuit 51 of the compensation circuit 37 explained in the first embodiment.

However, although the image data 23 obtained by noninterlace scanning is explained with examples in the above first embodiment, in the present embodiment, image data S23 is obtained by any of noninterlace scanning and interlace scanning.

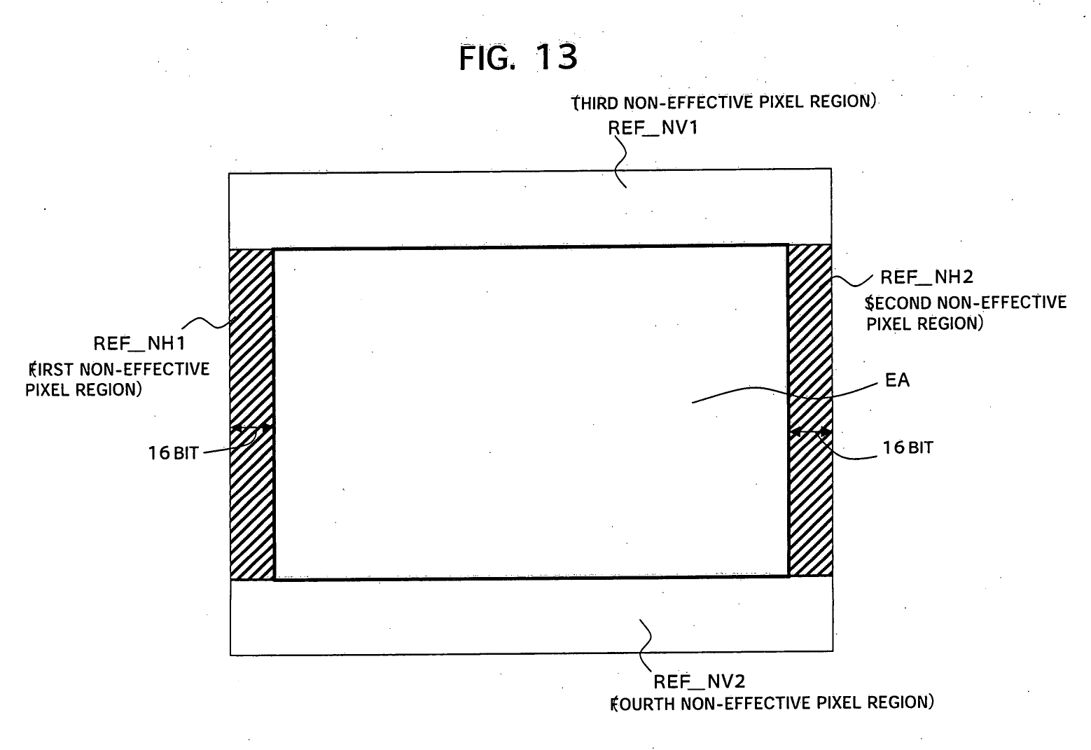

A non-effective pixel region composing circuit 51a of the present invention, in a step ST4 shown in FIG. 11, as shown in FIG. 13, generates reference image data REF_NH1 of the first non-effective pixel region and reference image data REF_NH2 of the second non-effective pixel region and writes it into the memory 35 in a way similar to the first embodiment based on reference image data of the effective pixel region.

That is to say, the non-effective pixel region composing circuit 51a does not perform generation of reference image data REF_NV1 of the third non-effective pixel region and reference image data REF_NV2 of the fourth non-effective pixel region and writing into the memory 35 in block.

The non-effective pixel region composing circuit 51a replicates pixel data necessary for the third and the fourth non-effective pixel region based on reference image data in the effective pixel region in the case that each of reference motion compensation block RMCB1 identified based on the motion vector MV by the motion prediction circuit 36 is located in the outside of both of the effective pixel region and the non-effective pixel region or astride the outside of them.

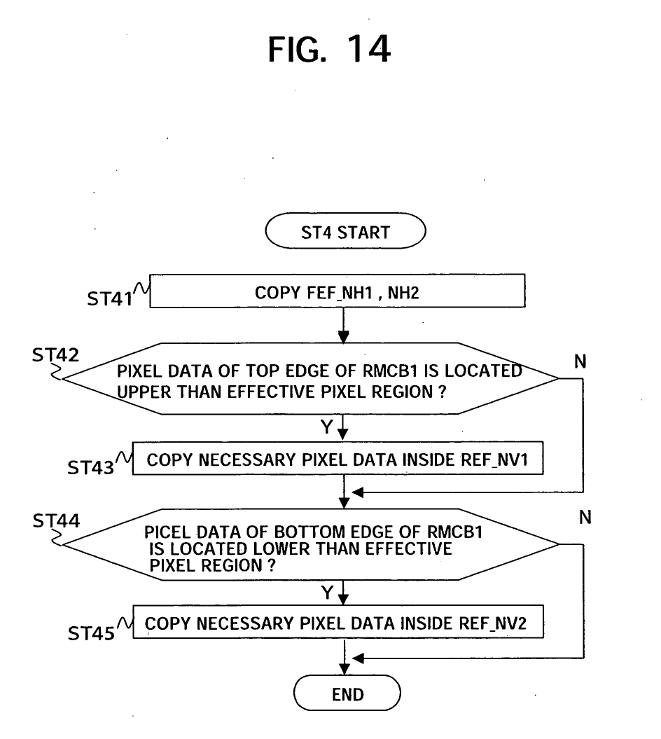

FIG. 14 is a view for explaining processing of the non-effective pixel region composing circuit 51a.

Step ST41:

The non-effective pixel region composing circuit 51a generates reference image data REF_NH1 of the first non-effective pixel region and reference image data REF_NH2 of the second non-effective pixel region and writes it into the memory 35 in a way similar to the first embodiment based on reference image data of the effective pixel region.

Step ST42:

The non-effective pixel region composing circuit 51a judges whether pixel data of the top edge (the most upper edge in a vertical direction V in FIG. 3) of the reference motion compensation block RMCB1 in reference image data identified by the motion vector MV1 from the MV transformation circuit 52 is located in the upper side than the effective pixel region in FIG. 3, and proceeds to a step ST43 when judging that it is located in the upper side, or proceeds to a step ST44 when it is not located in the upper side.

Step ST43:

The non-effective pixel region composing circuit 51a replicates pixel data inside the effective pixel region on the above mentioned third side L3 which position is equal to the region judged locating in the upper side of the effective pixel region in the step ST42 in a horizontal direction H in the above mentioned region, and writes it into the memory 35 as a portion of the reference image data REF_NV1.

Step ST44:

The non-effective pixel region composing circuit 51a judges whether pixel data of the bottom edge (the most lower edge in a vertical direction V in FIG. 3) of the reference motion compensation block RMCB1 in reference image data identified by the motion vector MV1 from the MV transformation circuit 52 is located in the lower side than the effective pixel region in FIG. 3, and proceeds to a step ST45 when judging that it is located in the lower side, or terminates the processing when it is not located in the lower side.

Step ST45:

The non-effective pixel region composing circuit 51a replicates pixel data inside the effective pixel region on the above mentioned fourth side L4 which position is equal to the region judged locating in the lower side of the effective pixel region in the step ST44 in a horizontal direction H in the above mentioned region, and writes it into the memory 35 as a portion of the reference image data REF_NV2.

In the present embodiment, in the case of mixing of the-noninterlace scanning and the interlace scanning, by generating the reference image data REF_NV1 and REF_NV2 only about necessary region and writing it into the memory 35, number of writing into the memory 35 can be reduced and processing efficiency can be improved.

### Third Embodiment

In the present embodiment, a decoding device 3 shown in FIG. 1 will be explained.

The present invention corresponds to a fourth invention.

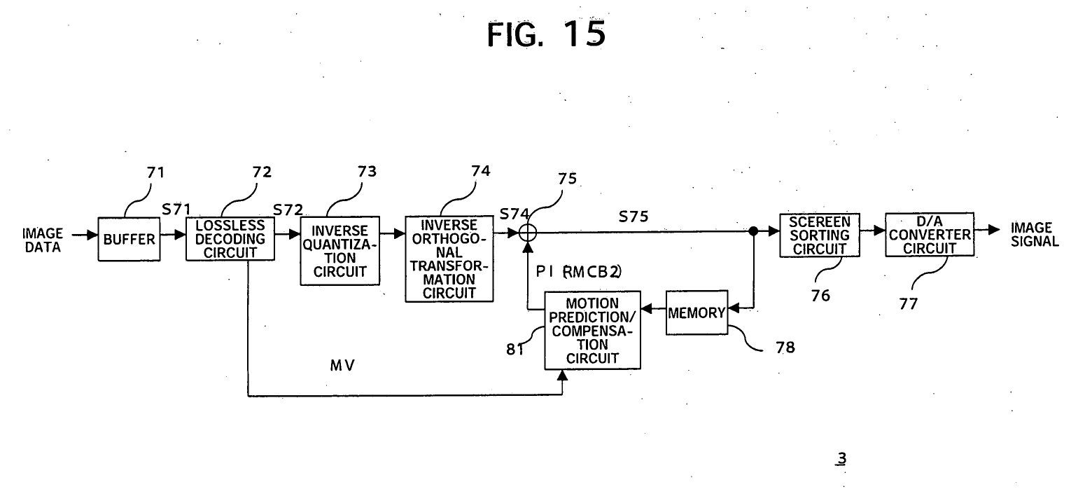

FIG. 15 is a functional block diagram of the decoding device 3 shown in FIG. 1.

As shown in FIG. 15, the decoding device 3 has, for example, an accumulation buffer 71, a lossless decoding circuit 72, an inverse quantization circuit 73, an inverse orthogonal transformation circuit 74, a calculation circuit 75, a screen sorting circuit 76, a D/A converter circuit 77, a memory 78 and a motion prediction/compensation circuit 81.

The inverse decoding circuit 72 corresponds to a decoder of the fourth invention, the memory 78 correspond to the memory of the fourth invention, the motion prediction/compensation circuit 81 corresponds to the motion compensation circuit fourth invention and the lo calculation circuit 75 corresponds to the calculator of the fourth invention.

When an image signal that is encoded by the encoding device 2 shown in FIG. 2, demodulated and transmitted is received, the accumulation buffer 71 stores image data obtained by the demodulation and the image data is decoded.

The lossless decoding circuit 72 performs decoding processing corresponding to encoding processing for image data S71 inputted from the accumulation buffer 71, the image data obtained by the processing is outputted to the inverse quantization circuit 73 and a motion vector MV obtained in the process of the decoding processing is outputted to the motion prediction/compensation circuit 81.

The inverse quantization transformation circuit 73 performs inverse orthogonal transformation corresponding to orthogonal transformation processing of the orthogonal transformation circuit 25 shown in FIG. 25 to image data inputted from the lossless decoding circuit 73, and image data obtained by the processing is outputted to the calculation circuit 75.

The calculation circuit 75 adds the image data S74 from the inverse orthogonal transformation circuit 74 and prediction image data PI from the motion prediction/compensation circuit 81 to generate image data S75, outputs it to the screen sorting circuit 76 and writes it into the memory 78.

The image data s75 written into the memory 78 is equal to reference image data REF_E inside the effective pixel region shown in FIG. 3.

The screen sorting circuit 76 generates an image signal that pictures indicated by the image data S75 are sorted in display order and outputs it to the D/A converter circuit 77.

The D/A converter circuit 77 converts digital image data inputted from the screen sorting circuit 76 to analog image data and outputs it.

The motion prediction/compensation circuit 81 generates prediction image data based on the motion vector MV inputted from the lossless decoding circuit 72 and the reference image data read out from the memory 78 and outputs it to the calculation circuit 75.

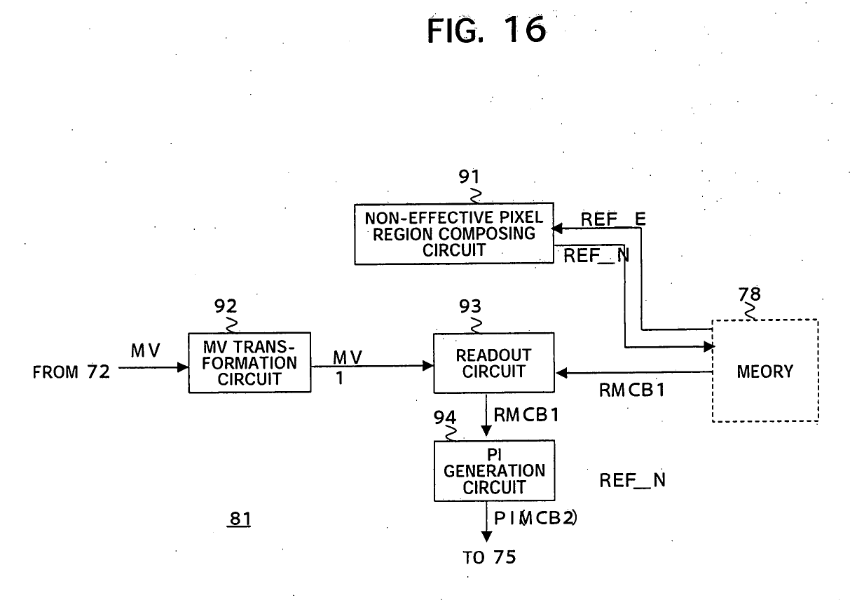

FIG. 16 is a block diagram of the motion prediction/compensation circuit 81 shown in FIG. 15.

As shown in FIG. 16, the motion prediction/compensation circuit 81 has, for example, a non-effective pixel region composing circuit 91, a MV transformation circuit 92, a readout circuit 93 and a PI generation circuit 94.

Here, a non-effective pixel region composing circuit 91, a MV transformation circuit 92, a readout circuit 93 and a PI generation circuit 94 are equal to the non-effective pixel region composing circuit 51, the MV transformation circuit 52, the readout circuit 53 and the PI generation circuit 54.

Here, the non-effective pixel region composing circuit 91 corresponds to a preprocessor of the fourth invention, the readout circuit 93 corresponds to a reader of the fourth invention, and the PI generation circuit corresponds to a generator of the fourth invention.

However, the non-effective pixel region composing circuit 91 and the readout circuit 93 accesses for the memory 78 shown in FIG. 78.

Further, the MV converter circuit 92 inputs a motion vector MV from the lossless decoding circuit 72 shown in FIG. 15.

Further, the PI generation circuit 94 outputs a motion compensation block MCB composing prediction image data PI for the calculation circuit 75 shown in FIG. 15.

Hereinafter, a whole operation example of the decoding device 3 will be explained.

In the decoding device 3, image data becoming as an input is outputted to the lossless decoding circuit 72 after storing to the buffer 71. Then, in the lossless decoding circuit 72, processing such as variable-length coding or arithmetic coding is performed based on a format of predetermined image compression information. At the same time, in the case that the frame is an inter-coded frame, in the lossless decoding circuit 72, the above mentioned operation is performed, and a motion vector VD stored in a header potion of an image signal is decoded and outputted to the motion prediction/compensation circuit 81.

A quantized transformation coefficient that becomes an output of the lossless decoding circuit 72 is inputted to the inverse quantization circuit 73 and a transformation coefficient is generated here. For the transformation coefficient, inverse orthogonal transformation such as inverse discrete cosine transformation and inverse Karhunen-Loeve transformation is performed based on a predetermined format of image compression information. In the case that the frame is an intra-coded frame, image information performed inverse orthogonal transformation processing is stored to the screen sorting circuit 76, and outputted through D/A conversion processing by the D/A converter circuit 77.

On the contrary, in the case that the frame is an inter-coded frame, in the motion prediction/compensation circuit 81, prediction image data PI is generated based on the motion vector MV and the reference image data stored in the memory 78, and this prediction data PI and image data S74 outputted from the inverse orthogonal transformation circuit 74 are added in the calculation circuit 75.

As explained above, in the decoding device 3, in the motion prediction/compensation circuit 81, before generating prediction image data PI, reference image data REF_NH1, NH2, NV1 and NV2 of the first to the fourth non-effective pixel region outside the effective pixel region shown in FIG. 6 is generated and written into the memory 35.

Then, the motion prediction/compensation circuit 81 reads out pixel data of reference motion compensation block RMCB indicated by the above-generated motion vector MV from the memory 35 and uses it for,generation of prediction image data PI without judging whether the pixel data is data within the effective pixel region or not.

Therefore, according to the decoding device 3, compared with a conventional device, prediction image data PI can be generated at short times.

Note that the present invention is not limited to the above embodiments and includes modifications within the scope of the claims.

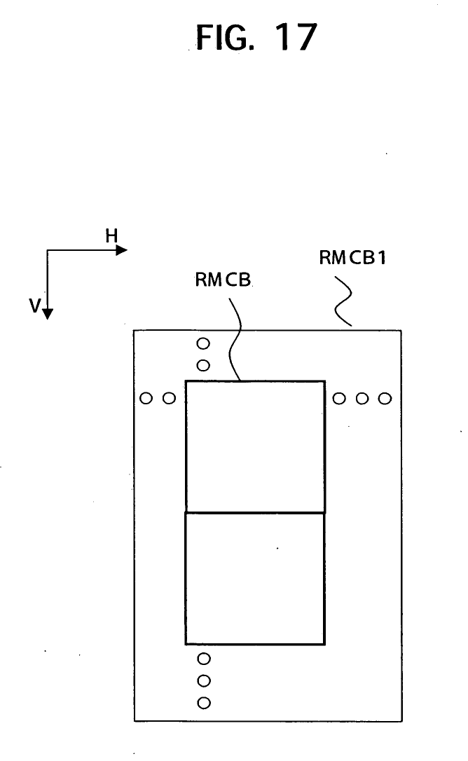

In the above mentioned embodiments, as block data of the present embodiments, the motion compensation block MCB shown in FIG. 8 is explained with examples, however, as shown in FIG. 17, a reference motion compensation block RMCB1 corresponding to macro block pairs composed by arranging two motion compensation blocks MCB in a vertical direction may be used.

1. A data processing device for generating prediction image data of image data of an encoding target or a decoding target based on a motion vector and first reference image data of an effective pixel region, comprising:
a memory for storing said first reference image data;
a preprocessor for generating second reference image data of a predetermined non-effective pixel region around said effective pixel region and writing it into said memory based on said first reference image data stored in said memory before generation of said prediction image data;
a reader for reading out said second reference image data written into said memory by said preprocessor based on said motion vector, in the case that said motion vector indicates said non-effective pixel region, and a generator for generating said prediction image data based on said second reference image data read out by said reader.

2. A data processing device as set forth in claim 1, wherein
said preprocessor transforms said motion vector so that it indicates the inside of said non-effective pixel region in the case that said motion vector indicates the outside of both of said effective pixel region and said non-effective pixel region,
said reader reads out said second reference image data from said memory based on said motion vector transformed by said preprocessor and generated.

3. A data processing device as set forth in claim 1, wherein said preprocessor transforms said motion vector so that in the case that said motion vector is prescribed about each of a plurality of block data composing said image data and a whole or a portion of reference block data indicated by said motion vector is located outside said effective pixel region and said non-effective pixel region, a whole of said reference block data falls within said non-effective pixel region.

4. A data processing device as set forth in claim 1, wherein said preprocessor transforms said motion vector so that in the case that said motion vector is prescribed about each of a plurality of block data composing said image data and reference block data indicated by said motion vector do not fall within said non-effective pixel region, each of divided reference block data obtained by dividing said reference block data falls within said non-effective pixel region.

5. A data processing device as set forth in claim 1, wherein said preprocessor
prescribes each of a first non-effective pixel region adjacent to said effective pixel region at a first side prescribing rectangular said effective pixel region and lengthening in a vertical direction perpendicular to a screen scanning direction, a second non-effective pixel region adjacent to said effective pixel region at a second side opposed to said first side and lengthening in said vertical direction, a third non-effective pixel region adjacent to said effective pixel region at a third side lengthening in a horizontal direction parallel with said screen scanning direction and a fourth non-effective pixel region adjacent to said effective pixel region at a fourth side opposed to said third side and lengthening in said horizontal direction in the case that only either of interlace scanning or noninterlace scanning is applied to a plurality of said image data generating said prediction image data, and
generates said second reference image data and writes it into said memory based on said first reference image data so that pixel data of a pixel position of said first non-effective pixel region is equal to pixel data within said effective pixel region on said first side which position in a vertical direction is equal to it, pixel data of a pixel position of said second non-effective pixel region is equal to pixel data within said effective pixel region on said second side which position in a vertical direction is equal to it, pixel data of a pixel position of said third non-effective pixel region is equal to pixel data within said effective pixel region lo on said third side which position in a horizontal direction is equal to it, and pixel data of a pixel position of said fourth non-effective pixel region is equal to pixel data within said effective pixel region on said fourth side which position in a horizontal direction is equal to it.

6. A data processing device as set forth in claim 1, wherein said preprocessor, in the case that said image data that interlace scanning is applied and said image data that noninterlace scanning is applied are mixed in a plurality of said image data generating said prediction image data,
prescribes each of a first non-effective pixel region adjacent to said effective pixel region at a first side prescribing rectangular said effective pixel region and lengthening in a vertical direction perpendicular to a screen scanning direction, a second non-effective pixel region adjacent to said effective pixel region at a second side opposed to said first side and lengthening in said vertical direction, and
generates said second reference image data and writes it into said memory based on said first reference image data so that pixel data of a pixel position of said first non-effective pixel region is equal to pixel data within said effective pixel region on said first side which position in a vertical direction is equal to it, pixel data of a pixel position of said second non-effective pixel region is equal to pixel data within said effective pixel region on said second side which position in a vertical direction is equal to it.

7. A data processing method generating prediction image data of image data of an encoding target or a decoding target based on a motion vector and first reference image data of an effective pixel region, comprising:
a first step of generating second reference image data of a predetermined non-effective pixel region around said effective pixel region and writing it into said memory based on said first reference image data stored in a memory;
a second step of reading out said second reference image data written into said memory in said first step based on said motion vector in the case that said motion vector indicates said non-effective pixel region, and a third step of generating said prediction image data based on said second reference image data read out from said memory in said second step.

8. An encoding device, comprising:
an encoder for encoding difference between encoded image data and prediction image data;
a memory for storing first reference image data of an effective pixel region;
a motion prediction circuit for generating a motion vector of said encoded image data, and
a motion compensation circuit for generating said prediction image data based on said motion vector generated by said motion prediction circuit and said reference image data stored in said memory,
wherein said motion compensation circuit comprises:
a preprocessor for generating second reference image data of a predetermined non-effective pixel region around said effective pixel region and writing it into said memory based on said first reference image data stored in said memory before generation of said prediction image data;
a reader for reading out said second reference image data written in said memory by said preprocessing process based on said motion vector in the case that said motion vector generated by said motion prediction circuit indicates said non-effective pixel region, and
a generator for generating said prediction image data based on said second reference image data read out by said reader.

9. A decoding device, comprising:
a decoder decoding image data as a decoding target;
a memory for storing first reference image data of a effective pixel region after decoding;
a motion compensation circuit for generating prediction image data based on a motion vector added to image data as said decoding target and said first reference image data read out from said memory, and
a calculator for adding said prediction image data generated by said motion compensation circuit and image data decoded and generated by said decoder,
wherein said motion compensation circuit comprises:
a preprocessor for generating second reference image data of a predetermined non-effective pixel region around said effective pixel region and writing it into said memory based on said first reference image data stored in said memory before generation of said prediction image data;
a reader for reading out said second reference image data written in said memory by said preprocessing process based on said motion vector in the case that said motion vector generated by said motion prediction circuit indicates said non-effective pixel region, and
a generator for generating said prediction image data based on said second reference image data read out by said reader.
